(19) United States
(12) Patent Application Publication
(10) Pub. No.: US 2019/0202188 A1
(43) Pub. Date: Jul. 4, 2019

(54) METHOD OF REDUCING ADHESIVE BUILD-UP ON ROLLER SURFACES

(71) Applicant: BOSTIK, INC., Wauwatosa, WI (US)

(72) Inventors: Steven Daniel GRAY, Mequon, WI (US); Ronald Frank GRAF, South Milwaukee, WI (US); David Frederic FREUND, Milwaukee, WI (US); Miao HU, Pewaukee, WI (US); Russell P. STUCZYNSKI, Waukesha, WI (US); Richard Edward HAMANN, New Berlin, WI (US); Jeffery Thomas OLSON, West Allis, WI (US)

(21) Appl. No.: 16/322,682

(22) PCT Filed: Feb. 8, 2017
(86) PCT No.: PCT/US2017/016964

§ 371 Date: Feb. 1, 2019

(51) Int. Cl. B32B 37/00; B32B 37/12; B32B 7/12; B32B 5/02; B32B 27/32; B32B 38/00; B32B 37/06; B32B 37/02; B32B 37/18

(52) U.S. Cl. CPC B32B 37/0053; B32B 37/1207; B32B 7/12; B32B 5/022; B32B 27/32; B32B 2323/10; B32B 37/06; B32B 37/02; B32B 37/182; B32B 2037/1215; B32B 2307/726; B32B 38/004

(57) ABSTRACT

Adhesive bleed-through of substrates and build-up of adhesive on process equipment can be reduced or even fully eliminated by increasing the running temperature of circumferential rolls (e.g., nip rollers or idlers) used to compress and adhesively bond the substrates of a laminate structure together, as opposed to the usual cooling of the nip rollers. This method is particularly beneficial when using polyolefin-based hot melt adhesives to form laminates with permeable substrates, such as low basis weight nonwovens, for use in disposable absorbent articles. The method can be used to make a range of laminated structures, such as bi-laminates and tri-laminates.

### CROSS-REFERENCE TO RELATED APPLICATION

This application claims the benefit of priority of PCT International Patent Application No. PCT/US2016/045904 filed on Aug. 5, 2016.

### FIELD OF THE INVENTION

This invention relates to methods of fabricating laminate structures having substrates bound together by a hot melt adhesive for use in applications such as disposable absorbent articles. More specifically, this invention relates to reducing, or completely eliminating, build-up of adhesive on process equipment. This is particularly useful when employing hot-melt adhesives with relatively low glass transition temperatures to form laminate articles with perforated films or permeable substrates.

### BACKGROUND OF THE INVENTION

Hot melt adhesives (HMAs) typically exist as solids at ambient temperature that can be converted to flowable liquid by the application of heat. The molten adhesive is applied to a substrate using a variety of application methods. A second substrate is often then laminated to the first substrate and the adhesive solidifies on cooling to form a strong bond. The major advantage of hot melt adhesives is the lack of a liquid carrier, as would be the case for water-based or solvent based adhesives, thereby eliminating the costly drying step during application. Also, hot melt adhesives can be formulated to have relatively short open times, and thus do not require any curing and/or crosslinking Therefore, hot melt adhesives typically have high “green” strength upon application. Suitable hot melt adhesives must possess the appropriate bond strength to adhere the substrates involved, and must also possess adequate flexibility, suitable viscosity, and open time to function on commercial equipment, as well as acceptable thermal stability under normal application temperatures.

Styrenic block copolymers (SBc) are commonly employed in hot-melt adhesive formulations used to produce laminate articles for a variety of end-use applications. The styrenic phase of the SBc is generally considered to offer the adhesive cohesive strength while the poly(diene) segments are thought to provide the elastomeric behavior needed to withstand mechanical forces and maintain a strong bond when the laminate structures undergo various stresses in end-use applications. Styrenic polymers are glassy in nature and possess relatively high order-disorder transition points. When freshly applied, it is generally believed that the styrenic portions develop properties rapidly to provide the cohesive strength required for the adhesive to evenly wet out the surface of porous substrates without over penetration. After applying the adhesives, the first-coated layer is often next compressed with additional films and substrates to form multilayer laminate articles.

When bonding permeable substrates, the temperatures of nip rollers have traditionally been controlled to values at or below ambient temperatures in an effort to promote adhesive vitrification and reduce the potential of any exposed adhesive being transferred to process equipment. Avoiding this type of transfer to process equipment is critical as build-up of adhesive on the compression system impedes the movement of the web through the tight nip-roller gaps commonly used to form strongly-bonded laminate articles. Such restrictions in the web movement can lead to process instability and, in severe cases, web breaks and line outages. Cooling nip roller temperatures to prevent build-up is well known in the art. While low temperatures are accepted as a means to control build-up, nip roller temperatures are generally maintained close to ambient values based on mechanical limitations, the energy costs associated with chilling, and hygiene concerns caused by the final article picking up moisture from condensation forming on highly cooled nip rollers.

U.S. Pat. No. 5,763,333 discloses a composite sheet comprising a liquid impermeable sheet and a nonwoven fabric joined to each other by an adhesive composition. The patent discloses the problem of adhesive undesirably bleeding (or migrating) through a nonwoven substrate, which is permeable, causing the nonwoven substrate to stick to the adjacent layer of a sheet. This phenomenon, called blocking, can result in a rolled composite sheet which will be broken or cling to itself when it is unrolled. This patent describes the use of a particular nonwoven substrate along with an adhesive having certain physical properties to reduce blocking.

### SUMMARY OF THE INVENTION

According to an embodiment of the invention, a method of using a hot melt adhesive comprises the steps of: heating a first circumferential roll to a temperature sufficient to at least significantly reduce build-up of adhesive on the first circumferential roll during operation; applying a hot melt adhesive to an adhesive-receiving surface of a first permeable substrate, wherein the first permeable substrate has a circumferential roll-contacting surface opposed from the adhesive-receiving surface; and conveying the first permeable substrate with the hot melt adhesive applied thereon such that the circumferential roll-contacting surface of the first permeable substrate contacts the heated first circumferential roll as the first permeable substrate is conveyed.

According to a further embodiment of the invention, a method of using a hot melt adhesive comprises the steps of: heating a first circumferential roll to a temperature sufficient to at least significantly reduce build-up of adhesive on the first circumferential roll during operation; applying a hot melt adhesive to an adhesive-receiving surface of a first permeable substrate, wherein the first permeable substrate has a circumferential roll-contacting surface opposed from the adhesive-receiving surface; conveying the first permeable substrate with the hot melt adhesive applied thereon such that the circumferential roll-contacting surface of the first permeable substrate contacts the heated first circumferential roll as the first permeable substrate is conveyed; and, after applying the hot melt adhesive to the adhesive-receiving surface of the first permeable substrate, contacting a second substrate with the adhesive-receiving surface of the first permeable substrate to form a bilaminate. According to a first aspect of this embodiment, the first circumferential roll comprises a first nip roller and the contacting step comprises exerting joining pressure on the first permeable substrate and the second substrate as the first permeable substrate and the second substrate are conveyed through a nip gap defined by the first nip roller and a second nip roller. According to a second aspect of this embodiment, the first circumferential roll comprises a first idler and the contacting step comprises exerting joining pressure on the first permeable substrate and the second substrate as the first permeable substrate and the second substrate are conveyed through at least one S-wrap curve formed by the first idler and a second idler positioned to contact the second substrate.

According to yet another embodiment of the invention, a method of using a hot melt adhesive comprises the steps of: heating a first circumferential roll to a temperature sufficient to at least significantly reduce build-up of adhesive on the first circumferential roll during operation; applying a hot melt adhesive to an adhesive-receiving surface of a first permeable substrate, wherein the first permeable substrate has a circumferential roll-contacting surface opposed from the adhesive-receiving surface; conveying the first permeable substrate with the hot melt adhesive applied thereon such that the circumferential roll-contacting surface of the first permeable substrate contacts the heated first circumferential roll as the first permeable substrate is conveyed; applying a hot melt adhesive to an adhesive-receiving surface of a second substrate, wherein the second substrate has a circumferential roll-contacting surface opposed from the adhesive-receiving surface; conveying the second substrate with the hot melt adhesive applied thereon such that the circumferential roll-contacting surface of the second substrate contacts a second circumferential roll as the second substrate is conveyed; introducing, after the steps of applying the hot melt adhesives to the adhesive-receiving surfaces of the first permeable substrate and the second substrate, a third substrate between the first permeable substrate and the second substrate; and contacting the third substrate with the adhesive-receiving surfaces of the first permeable substrate and the second substrate to form a trilaminate. According to a first aspect of this embodiment, the first circumferential roll comprises a first nip roller and the contacting step comprises exerting joining pressure on the first permeable substrate, the second substrate, and the third substrate as the first permeable substrate, the second substrate, and the third substrate are conveyed through a nip gap defined by the first nip roller and a second nip roller. According to a second aspect of this embodiment, the first circumferential roll comprises a first idler and the contacting step comprises exerting joining pressure on the first permeable substrate, the second substrate, and the third substrate as the first permeable substrate, the second substrate, and the third substrate are conveyed through at least one S-wrap curve formed by the first idler and a second idler positioned to contact the second substrate.

According to still another embodiment of the invention, a method for reducing hot melt adhesive build-up on process equipment surfaces comprises the steps of: a) providing a first roller having a first circumferential surface; b) providing a second roller aligned with the first roller and having a second circumferential surface, the second circumferential surface spaced from the first circumferential surface to form a nip gap there between; c) providing a first substrate having a first adhesive-receiving surface; d) providing a second surface aligned with the first substrate and having a second adhesive-receiving surface, the second adhesive-receiving surface facing the first adhesive-receiving surface; e) applying the hot melt adhesive composition to one or both of the first and second adhesive-receiving surfaces; f) actively controlling the first or second or both circumferential surfaces to temperatures near the rheological crossover temperature, Tx, of the hot melt adhesive composition; and g) feeding the first and second substrates with the hot melt adhesive composition applied thereon to the nip formed by the first and second rollers in order to compress the substrates together under heat and pressure to bond the first substrate to the second substrate to form a laminate structure.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice, the various features of the drawing are not to scale. Included in the drawing are the following figures:

FIG. 1 is a schematic drawing of a system for making a bilaminate according to a first embodiment of the present invention;

FIG. 2 is a schematic drawing of a system for making a bilaminate according to a second embodiment of the present invention;

FIG. 3 is a schematic drawing of a system for making a trilaminate according to a third embodiment of the present invention; and

FIG. 4 is a schematic drawing of a system for making a trilaminate according to a fourth embodiment of the present invention;

### DETAILED DESCRIPTION OF THE INVENTION

The present invention is directed towards methods of reducing or eliminating adhesive build-up on the surfaces of equipment used for manufacturing laminates incorporated into absorbent articles, such as disposable diapers, training pants, absorbent underwear, adult incontinence products, feminine hygiene products, and surgical drapes. The present method also reduces or eliminates adhesive build-up on nip rollers and other process equipment when using permeable substrates, such as perforated films and low-basis weight nonwovens, to construct the laminates. Such build-up, which can result in blocking of the formed laminate, occurs by adhesive undesirably bleeding through or migrating across permeable substrates as a result of the joining pressures exerted upon the substrates during the lamination process.

The present invention may be used in connection with a wide range of systems used to make laminates using hot melt adhesives. Any system which utilizes one or more circumferential rolls are appropriate for use with the present invention. Circumferential rolls are any generally cylindrical body which either serve to convey or direct a substrate being laminated or coated with an adhesive. Typical circumferential rolls include nip rollers and idlers. Nip rollers used in lamination processes are commonly cooled to prevent build-up on process equipment when employing hot melt adhesives to bond permeable or porous substrates. Despite the widespread use of chilled rollers, practical limitations exist employing this method. Generally, this method is most effective when the nip rollers can be controlled at or below the vitrification temperature of the adhesive where tack is highly reduced and the flow restricted. When employing adhesives with low glass transition temperatures—notably those with Tg values below 35° C.—this method can be problematic as chilling capacities must overcome frictional forces and thermal build-up experienced at high production rates. Additionally, certain end-use applications cannot tolerate any potential moisture contamination offered when rollers are chilled below the dew point leading to surface condensation.

While the invention described herein can be utilized in a general sense to improve the process behavior of SBc and EVA systems, it is particularly beneficial when employed in conjunction with hot-melt adhesives containing semi-crystalline polymers such as polyolefins that typically display glass transition (Tg) values below 35° C. Quite surprisingly, it has been found that build-up of adhesive on process equipment can be reduced and even fully eliminated through judicious selection of the running temperature of the circumferential rolls, including the temperature of the circumferential rolls at start-up. As used herein, start-up is defined as the point in a process at which adhesive is first introduced to a processing line after the system has been shut down and cooled to room temperature, about room temperature, or substantially below operating temperature, such as is typically achieved in an overnight shut-down.

This method is particularly beneficial when using hot melt adhesives to form laminated structures with permeable substrates, such as low basis weight nonwovens or perforated films. As used herein, a “permeable substrate” is one which allows for an undesirable amount of build-up on circumferential rolls at room temperature based on the given operating conditions and adhesive selected. As will be demonstrated below, careful selection of process conditions based on rheological properties of the adhesive can be applied in a general sense to limit adhesive bleed-through and build-up, as explained herein and as shown in the Examples. The inventive method does not negatively impact manufacturing costs and eliminates moisture/condensation concerns using highly chilled rollers. Using this method, circumferential roll temperatures can be set to increase bonding or maintain target values at lower adhesive add-on. Bonds can be further improved by increasing compression using tighter nip gaps not accessible without adhesive build-up on equipment using previous methods well-known in the art.

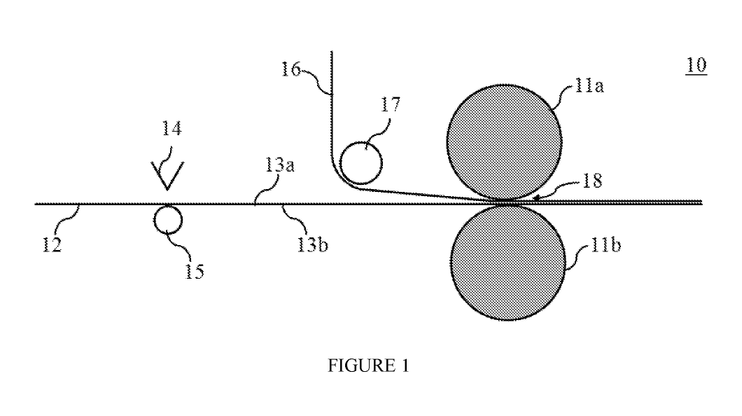

As shown in FIG. 1, a system of using a hot melt adhesive to form a laminated structure includes a pair of nip rollers 11a, 11b used in a conventional way to convey a first permeable substrate 12 in a lamination line (or processing line). First permeable substrate 12, which may be a nonwoven substrate such as those used in a diaper, has an adhesive-receiving surface 13a and a circumferential roll-contacting surface 13b opposed from the adhesive-receiving surface. An applicator 14 applies hot melt adhesive to adhesive-receiving surface 13a of first permeable substrate 12 in a known way. For example, contact coating applicators such as slot coating and non contact coating applicators such as controlled fiberization, random fiberization, and curtain coating, may be used. System 10 further comprises an idler 15 for providing a surface along which first substrate 12 can be conveyed in a known way. System 10 further comprises a second substrate 16 which will be adhered to first substrate 12 to form a bilaminate. Idler 17 provides a surface along which second substrate 16 can be conveyed in a known way. Nip rollers 11a and 11b, which are aligned axially with one another, define a nip gap 18 which applies joining pressure to first substrate 12 and second substrate 16 to cause the two substrates to join through the solidification by cooling of the hot melt adhesive and thus form a bilaminate.

In operation, a method of using a hot melt adhesive to form a bilaminate using system 10 comprises heating nip roller 11b to a temperature sufficient to at least significantly reduce build-up of adhesive on nip roller 11b during operation. As explained in the examples below, in some systems, adhesive builds up on the nip roller on the side of a permeable substrate opposite to which adhesive is applied. It has been discovered that the build-up can be reduced and substantially eliminated by heating the nip roller to a temperature approaching the crossover temperature of the adhesive, as described below. Preferably, the selected temperature reduces build-up of adhesive on nip roller 11b during operation such that less than 3% of the products produced by the laminating line are defective due to blocking. More preferably, the selected temperature achieves less than 1% of the products produced by the laminating line being defective due to blocking. As explained below, appropriate temperatures suitable for heating of the nip roller can be at least about 50° C. or higher, more preferably about 60° C. or higher, still more preferably about 70° C. or higher, and even more preferably about 80° C. or higher.

Another way of identifying the desired temperature of the nip roller is to identify the temperature of the nip roller in terms of the crossover temperature of the adhesive (referred to herein as the crossover temperature or rheological crossover). The nip roller is preferably controlled to a temperature near, at, or above the rheological crossover, Tx, of the adhesive. The Tx is defined as the highest temperature at which the storage modulus, G′, and loss modulus, G″, intersect as measured using dynamic mechanical analysis (DMA) of the adhesive while cooled from the molten to solid state. The test method used is ASTM D 4440-01, with a cooling rate of 10° C./min. The first roller may be heated to values of at least about −30° C. of the Tx, more preferably at least about −20° C. of the Tx, still more preferably at least about −10° C. of the Tx and even more preferably at about the value of the Tx (e.g., ±5° C. of the Tx). In general, the Tx of the adhesive used is at least 25° C. above room temperature; thus, the nip rollers need to be heated at some point to achieve the purposes of the present invention.

The upper limit of the temperature of the nip roller may vary over a wide range and may be dictated by the decomposition temperature of the adhesive or simply by cost (i.e., heating the circumferential rolls to temperatures above that which is needed to attain the effects of the invention is undesirable and unduly costly). Exemplary upper limits include +60° C. of the Tx, more preferably +40° C. of the Tx, even more preferably +20° C. of the Tx, and still more preferably +10° C. of the Tx. The invention includes any combination of a desired lower limit of absolute temperature, a lower limit of the temperature based on the Tx, and any upper limit (or no upper limit) More specifically, the invention includes selecting a lower limit of the desired temperature range of the circumferential roll to be the greater of: (1) any of 50° C., 60° C., 70° C., or 80° C. or (2) any of −30° C. of the Tx, −20° C. of the Tx, −10° C. of the Tx or −5° C. of the Tx and either no upper limit or an upper limit of any of +60° C. of the Tx, +40° C. of the Tx, +20° C. of the Tx, or +10° C. of the Tx. Therefore, an exemplary range according to an embodiment of the invention is heating the circumferential roll to a temperature of the higher of at least 60° C. or about −20° C. of the Tx and to an upper limit of +40° C. of the Tx. Likewise, if a second permeable substrate is used, which is the case in some embodiments, then a circumferential roll associated with that second permeable substrate is heated to any temperature range as described herein.

When referring to the temperature of the nip roller, an idler, or any circumferential roll herein, the relevant specific part of such components is the circumferential surface of the nip roller, idler, or circumferential roll. Conventional methods for determining temperature of the circumferential surface of the circumferential roll can be employed, such as by use of one or more thermocouples. In addition, conventional ways of heating the circumferential rolls may also be employed, such as by using an external source of heat. According to an embodiment of the invention, the temperature of the first circumferential roll is monitored during operation. Based on the feedback from the monitoring, the amount of heat applied to the first circumferential roll is controlled to ensure that the desired temperature or temperature range is maintained.

Referring to FIG. 1, the method of using a hot melt adhesive to make a laminated structure also comprises the step of applying a hot melt adhesive to adhesive-receiving surface 13a of first permeable substrate 12. The method of application of the hot melt adhesive can vary over a range of conventional application methods. The method further comprises conveying first permeable substrate 12 with the hot melt adhesive applied thereon such that circumferential roll-contacting surface 13b of the first permeable substrate contacts the heated nip roller 11b as the first permeable substrate is conveyed. Although shown in FIG. 1 as the permeable substrate being substrate 12 to which the adhesive is applied, substrate 16 could be the permeable substrate or both substrates could be permeable. If substrate 16 is permeable, then nip roller 11a may be heated also to reduce build-up in a manner consistent with that described above in connection with nip roller 11b. Nip roller 11a can be said to be “associated with” substrate 16 because it is that nip roller which would be the subject of adhesive build-up caused by adhesive bleeding through substrate 16.

With reference to FIG. 1, the method of using the hot melt adhesive further comprises, after applying the hot melt adhesive to adhesive-receiving surface 13a of first permeable substrate 12, contacting second substrate 16 with the adhesive-receiving surface of the first permeable substrate to form a bilaminate. This contacting is done in a conventional way by conveying the substrates through nip gap 18 defined by nip rollers 11a and 11b. As is well known, nip gap 18 is sized to exert a joining pressure on first permeable substrate 12 and second substrate 16 as the first permeable substrate and the second substrate are conveyed through the nip gap defined by first nip roller 11a and second nip roller 11b.

According to an embodiment of the invention, a method of using a hot melt adhesive comprises using the hot melt adhesive to coat a substrate. A system similar to system 10 in FIG. 1 could be used, except that no second substrate 16 is used. In such embodiments, the adhesive used is generally tack-free so that the coated substrate could be rolled. As described above, the method comprises heating circumferential roll 11b to a temperature sufficient to at least significantly reduce build-up of adhesive on the circumferential roll during operation. The method also comprises applying a hot melt adhesive to adhesive-receiving surface 13a of permeable substrate 12, wherein the permeable substrate has a circumferential roll-contacting surface 13b opposed from the adhesive-receiving surface. The method further comprises conveying permeable substrate 12 with the hot melt adhesive applied thereon such that circumferential roll-contacting surface 13b of the permeable substrate contacts heated circumferential roll 11b as the permeable substrate is conveyed. Thus, a permeable substrate coated with an adhesive is formed. In an alternative embodiment, the method further comprises folding permeable substrate 12 such that inner surfaces of the adhesive-receiving surface 13a are adjacent with one another prior to circumferential roll-contacting surface 13b of the permeable substrate contacting heated nip roller 11b. In this embodiment, it is preferable that both nip rollers 11a and 11b are heated. Thus, a permeable substrate folded over on itself and bound with an adhesive is formed. Exemplary products which fit this description include a diaper inner leg cuff.

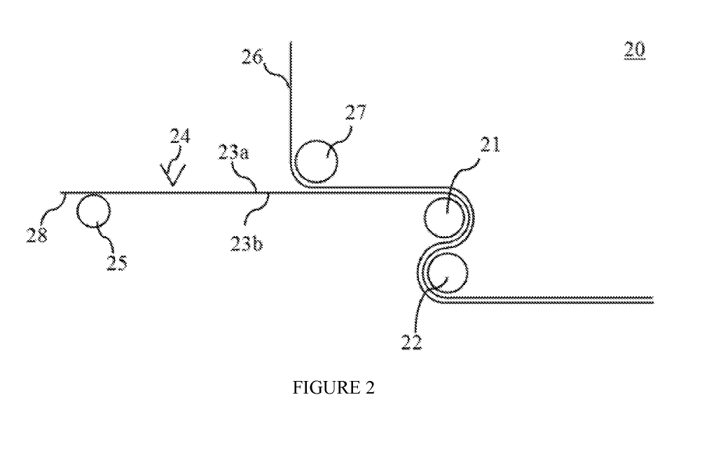

According to the system shown in FIG. 2, system 20 employs an S-wrap configuration to exert joining pressure to bond the substrates. Similar to the embodiment shown in FIG. 1, system 20 comprises: a first permeable substrate 28 having an adhesive-receiving surface 23a and a circumferential roll-contacting surface 23b; an applicator 24 for applying hot melt adhesive to the adhesive-receiving surface of the first substrate; an idler 25 for providing a surface along which the first substrate can be conveyed in a known way; a second substrate 26; and an idler 27 for providing a surface along which the second substrate can be conveyed in a known way. Instead of using the joining force exerted by the nip rollers in system 10 of FIG. 1, system 20 shown in FIG. 2 uses the tension provided by an S-wrap configuration to exert a joining force on the substrates to form a laminate. In the embodiment shown in FIG. 2, a heated idler 21 contacts circumferential roll-contacting surface 23b of first substrate 28 and an idler 22 is positioned to contact second substrate 26 as it is being conveyed. As such, the conveyed substrates from an S-wrap path as shown in FIG. 2. Although only two idlers 21 and 22 are shown and are needed to provide an S-wrap configuration to provide a joining force, alternative embodiments could employ two series of idlers to provide a path of substrate travel which forms multiple S-curves in an S-wrap configuration.

According to the method for using the hot melt adhesive using the system shown in FIG. 2, first permeable substrate 28 with adhesive applied to adhesive-contacting surface 23a and second substrate 26 are contacted with one another by exerting joining pressure on the first permeable substrate and the second substrate as the first permeable substrate and the second substrate are conveyed through at least one S-wrap curve. As discussed herein, first substrate 28 is permeable in the embodiment shown in FIG. 2, so idler 21 serves as the heated circumferential rolls and is heated to a temperature sufficient to at least significantly reduce build-up of adhesive on the idler 21 during operation. Alternatively, second substrate 26 may be permeable instead of, or in addition to, first substrate 28. In the event that second substrate 26 is permeable, then idler 22 would be heated in a manner similar to heated idler 21.

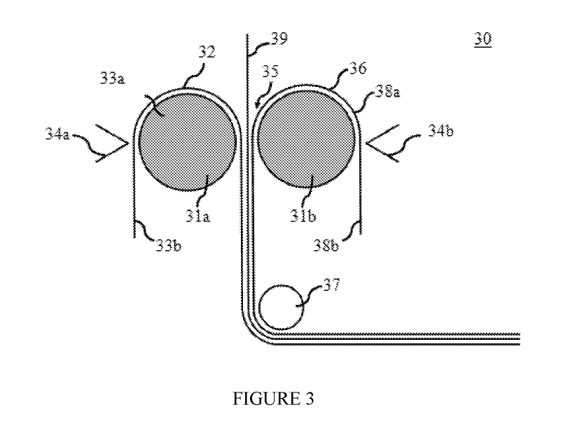

FIG. 3 is a schematic drawing of a system 30 for making a trilaminate according to another embodiment of the present invention. In system 30, the circumferential rolls are nip rollers. System 30 comprises a first nip roller 31a; a second nip roller 31b; a first substrate 32 having an adhesive-receiving surface 33a and a circumferential roll-contacting surface 33b opposed from the adhesive-receiving surface; and a second substrate 36 having an adhesive-receiving surface 38a and a circumferential roll-contacting surface 38b opposed from the adhesive-receiving surface. System 30 further comprises applicators 34a and 34b for applying hot melt adhesive to the adhesive receiving surfaces of first substrate 32 and second substrate 36, respectively. System 30 further comprises a third substrate 39 which is to be disposed in between first substrate 32 and second substrate 36. An idler 37 serves to provide a surface along with the formed trilaminate can be conveyed, in a known way.

In use, system 30 can be used to make a trilaminate by using a hot melt adhesive in a way which reduces or eliminates build-up of adhesive on either nip roller which is associated with a permeable substrate. For example, first substrate 32 may be a permeable substrate, such as a nonwoven, which, but for this invention, would otherwise be subject to bleed-through or migration of adhesive across the substrate from adhesive-receiving surface 33a to circumferential roll-contacting surface 33b during operation of the line. As in prior embodiments, nip roller 31a is heated to a temperature sufficient to at least significantly reduce build-up of adhesive on the nip roller 31a during operation. The manner in which nip roller 31a may be heated is well-known. Preferably, nip roller 31a is heated prior to start up and the heat is maintained to achieve the desired temperature or temperature range (e.g., ±10° C. of the desired temperature) during operation. As in the previous embodiments, first substrate 32 with the hot melt adhesive applied thereon is conveyed such that circumferential roll-contacting surface 33b of the first substrate contacts heated nip roller 31a as the first permeable substrate is conveyed.

The method of operating system 30 also includes applying a hot melt adhesive to adhesive-receiving surface 38a of second substrate 36, wherein the second substrate has a circumferential roll-contacting surface 38b opposed from the adhesive-receiving surface. Similar to first substrate 32, second substrate 36 with the hot melt adhesive applied thereon is conveyed such that circumferential roll-contacting surface 38b of the second substrate contacts second nip roller as the second substrate is conveyed. After the steps of applying the hot melt adhesives to the adhesive-receiving surfaces of first substrate 32 and second substrate 36, a third substrate 39 is introduced between the first substrate and the second substrate. Third substrate 39 is contacted with the adhesive-receiving surfaces of first substrate 32 and second substrate 36 to form a trilaminate. The contacting step of the three substrates with one another comprises exerting joining pressure on first substrate 32, second substrate 36, and third substrate 39 as the three substrates are conveyed through a nip gap 35 defined by first nip roller 31a and second nip roller 31b. The joining pressure is applied in a direction from each circumferential roll-contacting surface of first substrate 32 and second substrate 36 inward to draw the three substrates together. As the trilaminate is conveyed, the hot melt adhesive solidifies, causing the three substrates to become bound. Although system 30 is described as first substrate 32 being permeable, second substrate 36 may, instead of or in addition to first substrate, be permeable. In that event, then nip roller 31b would also be heated to a temperature sufficient to at least significantly reduce build-up of adhesive on the nip roller 31b during operation. Typical trilaminate products which might be formed according to this process are stretchable laminates for diaper, training pants, or adult incontinence side panels. In some products, first substrate 32 may be a nonwoven, second substrate 36 may be a nonwoven, and third substrate 39 may be an elastomeric film.

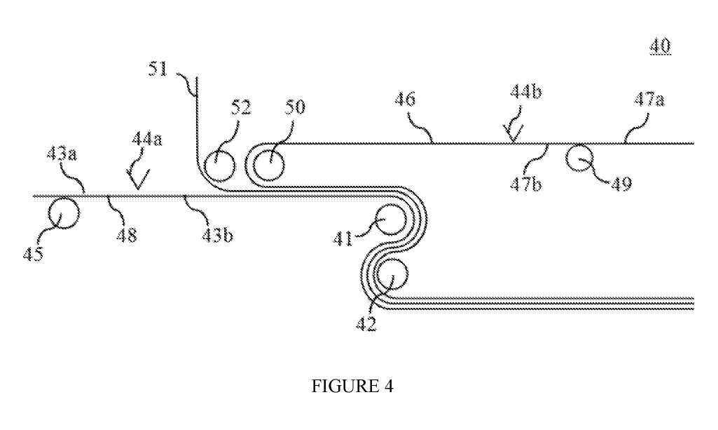

FIG. 4 is a schematic drawing of a system 30 for making a trilaminate according to another embodiment of the present invention, which employs an S-wrap configuration to exert joining pressure to bond the substrates. In system 40, the circumferential rolls are idlers 41 and 42. Similar to the embodiment shown in FIG. 3, system 40 comprises: a first permeable substrate 48 having an adhesive-receiving surface 43a and a circumferential roll-contacting surface 43b; an applicator 44a for applying hot melt adhesive to the adhesive-receiving surface of the first substrate; a second substrate 46 having an adhesive-receiving surface 47a and a circumferential roll-contacting surface 47b; and an applicator 44b for applying hot melt adhesive to the adhesive-receiving surface of the second substrate. System 40 also comprises an idler 45 for providing a surface along which first substrate 48 can be conveyed in a known way and an idler 49 for providing a surface along which second substrate 46 can be conveyed in a known way. Instead of using the joining force exerted by the nip rollers in the systems shown in FIGS. 1 and 3, system 40 shown in FIG. 4 uses the tension provided by an S-wrap configuration to exert a joining force on the substrates to form a laminate. In the embodiment shown in FIG. 4, a heated idler 41 contacts the circumferential roll-contacting surface of first substrate 48 and an idler 42, is positioned to contact second substrate 46 as it is being conveyed. As such, the conveyed substrates form an S-wrap path as shown in FIG. 4. Although only two idlers 41 and 42 are shown and needed to provide an S-wrap configuration, alternative embodiments include using two series of idlers to provide a path of substrate travel which forms multiple S-curves in an S-wrap configuration. System 40 further comprises a third substrate 51 which is to be disposed in between first substrate 48 and second substrate 46. An idler 52 serves to provide a surface along with third substrate 51 can be conveyed, in a known way.

In use, system 40 can be used to make a trilaminate by using a hot melt adhesive in a way which reduces or eliminates build-up of adhesive on any idler which is associated with a permeable substrate. For example, first substrate 48 may be a permeable substrate, such as a nonwoven, which, but for this invention, would otherwise be subject to bleed-through or migration of adhesive across the substrate from adhesive-receiving surface 43a to circumferential roll-contacting surface 43b during operation of the line. As in prior embodiments, the idler 41 is heated to a temperature sufficient to at least significantly reduce build-up of adhesive on these idlers during operation. The manner in which idler 41 may be heated is well-known. Preferably, idler 41 is heated prior to start up and the heat is maintained to achieve the desired temperature or temperature range (e.g., ±10° C. of the desired temperature) during operation. As in the previous embodiments, first substrate 48 with the hot melt adhesive applied thereon is conveyed such that circumferential roll-contacting surface 43b of the first substrate contacts heated idler 41 as the first permeable substrate is conveyed.

The method of operating system 40 also includes applying a hot melt adhesive to adhesive-receiving surface 47a of second substrate 46, wherein the second substrate has a circumferential roll-contacting surface 47b opposed from the adhesive-receiving surface. Similar to first substrate 48, second substrate 46 with the hot melt adhesive applied thereon is conveyed such that circumferential roll-contacting surface 47b of the second substrate contacts second idler 42 as the second substrate is conveyed. After the steps of applying the hot melt adhesives to the adhesive-receiving surfaces of first substrate 48 and second substrate 46, a third substrate 51 is introduced between the first substrate and the second substrate. Third substrate 51 is contacted with the adhesive-receiving surfaces of first substrate 48 and second substrate 46 to form a trilaminate.

The contacting step of the three substrates with one another comprises exerting joining pressure on first substrate 48, second substrate 46, and third substrate 51 as the three substrates are conveyed through across the S-Wrap configuration provided by the positioning of idlers 41 and 42. The joining pressure is applied in a direction from each circumferential roll-contacting surface of first substrate 48 and second substrate 46 inward to draw the three substrates together. As the trilaminate is conveyed, the hot melt adhesive solidifies, causing the three substrates to become bound. Although system 40 is described as first substrate 48 being permeable, second substrate 36 may, instead of or in addition to the first substrate, be permeable. In that event, then idler 42 would also be heated to a temperature sufficient to at least significantly reduce build-up of adhesive on these idlers during operation. Typical trilaminate products which might be formed according to this process are stretchable laminates for diaper, training pants or adult incontinence side panels. In some products, first substrate 48 may be a nonwoven, second substrate 46 may be a nonwoven, and third substrate 51 may be an elastomeric film.

The invention encompasses various modifications to the systems shown in FIGS. 1-4. For example, the various idlers may serve to drive the substrates as conveyors. In addition, the components adjacent the applicators described as idlers may alternatively serve as driven backing rolls instead. Also, in the systems shown in FIGS. 3 and 4, the applicators are shown as applying adhesive to the first and second substrates. Alternatively or in addition to this, an applicator may apply adhesive to one or both sides of the third substrate. As discussed above, a primary benefit of the invention is eliminating or reducing build-up of adhesive on circumferential rolls associated with permeable substrates. Viewed another way, the invention also permits a greater joining force to be exerted on the substrates with the same extent of build-up resulting from a lesser joining force. Thus, a greater bond strength could be achieved or an equal bond strength but a lower add-on weight could be used.

Regardless of the system configuration that is employed, this method is suitable to a wide range of commercial adhesives, including commercial adhesives based on SBc and EVA polymers well-known in the art. It is especially useful when bonding low-basis weight permeable substrates. It is further beneficial to employ this inventive method when using hot-melt adhesives containing semi-crystalline polymers that display low glass transition values where low glass transition values are defined as being below 35° C. The semi-crystalline polymer used in the hot melt adhesive composition is preferably a polyolefin or polyolefin blend. The polyolefin or polyolefin blend is more preferably selected from the group consisting of homopolymers, copolymers and terpolymers derived from ethylene, propylene, 1-butene, 1-hexene, 1-octene and combinations thereof. The most preferred polyolefin is an ethylene-based copolymer or a propylene-based copolymer.

More generally, the invention is suitable on a wide range of adhesives, including those based on polyolefins. Such adhesives can utilize a single polyolefin or, more preferably, mixtures of polyolefins. Especially well-suited polyolefins include those of generated from ethylene and propylene. In the case of polyethylene systems, those containing α-olefin comonomers such as 1-butene, 1-hexene, 1-octene and/or the like which serve to disrupt polymer crystallinity can used to produce adhesives that melt readily and can easily be applied via numerous coating methods. Generally, medium density (0.940-0.915 g/mL) and linear low-density (<0.915 g/mL) ethylene-based polymers are suitable for such applications though low molecular weight, higher density polyethylene can be employed provided they display adequate melt compatibility. Branched low-density polyethylenes referred to as low-density polyethylene (LDPE) may also be used. The ethylene-based copolymers may have the comonomer units randomly distributed as is common in medium-density polyethylenes, low-density polyethylenes (LDPE) and linear-low-density polyethylene (LLDPE). Conversely, olefin block copolymers where the commoner is present in different concentrations in discrete segments of the polymer chain may be also employed. The polyethylene backbone may be highly linear or contain some or many long-chain branches.

Adhesives consisting of propylene-based polymers and copolymers can also be exploited in the current invention. Suitable polypropylene species include isotactic, syndiotactic, and atactic propylene homopolymers copolymers. Polypropylenes designed to possess a controlled level of stereoerrors to modulate the melting behavior and mechanical properties can also be employed as required to for the bonding application. Propylene based copolymers and terpolymers that can also be employed as components in adhesives for the current invention include those with relatively low levels (<5 mole %) of ethylene, 1-butene, and/or higher α-olefin comonomer which are commonly referred to as random copolymers. These include polypropylene-co-olefin) copolymers and terpolymers with relatively high crystallinity that display melting points in the range of 130 to 165° C. Propylene based copolymers and terpolymers with relatively high levels (>5 mole %) of ethylene, 1-butene, and/or higher α-olefin comonomer can also be employed as components in adhesives for the current invention.

Additionally, heterophasic polypropylenes commonly referred to as impact copolymers (ICP) that consist contain a rubbery ethylene-propylene or ethylene-propylene-1-butene polymer phase within a polypropylene or propylene copolymer matrix may also be employed.

Propylene polymers suitable for the present invention may be reactor grade materials or controlled rheology polymers produced via chain scission methods commonly practiced in the commercial production.

In addition to ethylene and propylene polymers, materials commonly referred to as amorphous poly-α-olefins, APAO, may also be employed. APAO polymers are selected from the group consisting of propylene-ethylene copolymer, propylene-1-butene copolymer and terpolymers of propylene, ethylene, and 1-butene.

In addition to these polymers, such adhesives may include: a tackifying agent; a plasticizer; a stabilizer or antioxidant; and additives, waxes, surfactants, fillers, nucleation packages, and/or other auxiliary components as required to adjust properties for end-use performance. Especially well-suited polyolefin-based adhesives for use in the present invention are described in US 20160102230, incorporated herein by reference. The adhesives described therein employ mixtures of polypropylene copolymers, polyolefin elastomers, and amorphous polyolefins. These adhesives exhibit excellent flow allowing them to evenly coat (“wet out”) substrates yet form strong initial bonds that are maintained upon long-term aging, making them useful for hygiene, construction, and packaging applications.

Waxes can also be used in the adhesive composition to decrease surface tack to improve the blocking resistance of the coated substrate, which is important if the fabricated article will be stored in roll form until it is used or if tack on the backside of permeable substrates is not desirable as is the case in certain hygiene applications. Relatively low amounts, 0.1 to about 15% by weight, of paraffin waxes, microcrystalline waxes, polyethylene waxes or polypropylene waxes and the like may also be used to adjust surface tack so long as the wax does not interfere with the level of performance required by the end use.

The method is very effective in reducing or preventing equipment build-up when employing permeable substrates such as nonwovens and perforated films (including screens) used in laminate structures. The invention is suitable for any substrate that, when exposed to a joining pressure under typical conditions, permit adhesive to bleed through or migrate across the substrate to the other side (i.e., from the adhesive-receiving surface to the circumferential roll-contacting surface). Most preferably, the permeable substrate is a low basis weight nonwoven, which is also porous. By “low basis weight,” it is meant a nonwoven that has a basis weight below about 60 grams per square meter (gsm). In some embodiments, the nonwoven has a basis weight below about 50 gsm, and even more preferably below about 40 gsm. In other embodiments, the nonwoven has a basis weight of between about 2 and about 30 gsm and more preferably between about 2 to about 20 gsm.

Without being bound to theory, it is believed that the build-up of adhesive on equipment is related to the rheological properties of the materials. For systems with glass transition, Tg, values above 35° C., nip temperatures can be readily maintained below the Tg. This reduces the tack of the any adhesive which may come into contact with process equipment and prevents or reduces build-up. For adhesives displaying relatively low glass transition values, specifically those with Tg values below 35° C., maintaining nip temperatures at or below the glass temperature can be difficult owing to frictional forces and thermal build-up during high speed production. Eliminating or reducing build-up in such cases is particularly challenging when employing low basis weight substrates.

The method of the present invention provides a novel method for making a laminate structure, such as a bilaminate or trilaminate. The method reduces or eliminates adhesive build-up on equipment when using HMA materials that display relatively low Tg values. It is of particular utility when using semi-crystalline-based hot melt adhesives to join permeable or porous substrates in laminate structures or to adhere a single substrate to itself by folding it over and contacting the inner surfaces of the folded portion with the adhesive.

### Examples

The following provides numerous examples of the use of increased nip roller temperatures to mitigate process equipment fouling with a variety of hot-melt adhesives.

In order to determine the appropriate nip roller temperature, dynamic mechanical analysis was performed on the various hot melt adhesives used in the examples below. A Rheometrics Dynamic Mechanical Analyzer (Model RDA III) was used to obtain the elastic (G′) and loss (G″) moduli for the adhesives as a function of temperature. Analyses were performed using 25 mm diameter parallel plates separated by a 1.6 mm gap. The adhesive sample was loaded and then heated from 140 to 170° C. at a rate of 10° C. per minute. The convection oven containing the sample was flushed continuously with nitrogen throughout the testing. The frequency was maintained at 10 rad/s, and the storage modulus (G′) and the loss modulus (G″) were calculated from the torque and strain data, which were collected as the sample was decreased 6° C./min. The crossover temperature, Tx, was is defined as the maximum temperature where G′ and G″ intersect. The glass transition temperature, Tg, is defined as the maximum value of the tan δ (G″/G′) curve below the cross-over temperature.

### Substrates:

A bi-laminate article was made consisting of a back sheet barrier film (Clopay BR134) bonded to a nonwoven (spunbond nonwoven, available from First Quality Nonwovens, 15 gsm) using a thin slot coated adhesive layer.

### Hot Melt Adhesives

The Example 1 test series employed H20080, which is a commercial SBc-containing hot melt adhesive available from Bostik, Inc., Wauwatosa, Wis. H20080 has a Ring and Ball Softening Point (“RBSP”; ASTM method E28-99) of 79° C. and a Brookfield viscosity (ASTM D 3236-88) of 2,100 cP at 149° C. In DMA testing, H20080 displays a glass transition temperature, Tg, of 20° C. and a crossover temperature, Tx, of 78° C.

The Example 2 test series employed H4356, which is a commercial SBC-containing hot melt adhesive available from Bostik, Inc., Wauwatosa, Wis. that has a RBSP of 83° C. and a Brookfield viscosity of 7000 cP at 163° C. In DMA testing, H4356 displays a Tg of 30° C. and a Tx of 89° C.

The Example 3 set of experiments employed the polyolefin-based hot-melt formulation shown in Table 1. The Example 3 adhesive has a RBSP of 127° C. and a Brookfield viscosity of 8,575 cP at 163° C. It displays a Tg of 23° C. and a Tx of 66° C.

TABLE 1
Formulation Employed in Example 3 Series

| Component | wt % |
|---|---|
| ^{a}Nyflex 228 Mineral Oil | 27.8 |
| ^{b}Para wax 150-152 | 4.0 |
| ^{c}Escorez 5615 | 43.3 |
| ^{d}Vistamaxx 6202 | 9.1 |
| ^{e}Pro-fax RP 591V | 15.1 |
| ^{f}Irgafos 168 | 0.4 |
| ^{g}Irganox 1010 | 0.4 |

^{a}Nyflex 222B is a hydrotreated napthenic process oil available from Nynas Corporation.
^{b}Para wax 150-152 is a hydrotreated paraffin wax with a 150° F. R&B softening point available from Calumet.
^{c}Escorez 5615 is a hydrogenated aromatic modified cycloaliphatic hydrocarbon resin with a 115° C. softening point. It is available from ExxonMobil Chemical.
^{d}Vistamaxx 6202 is a metallocene catalyzed propylene based elastomer available from ExxonMobil Chemicals. It contains 85% propylene and 15% ethylene by weight. It has a Melt Index (190° C./2.16 kg) of 9.1 g/10 min and a density of 0.863 g/cc.
^{e}Pro-fax RP591V is a random propylene copolymer available from Lyondellbasell Polymers. RP591V has a Melt Flow Rate (230° C./2.16 kg) of 100 g/10 min and a density of 0.90 g/cc.
^{f}Irgafos 168 is hydrolytically stable phosphite processing stabilizer available from BASF.
^{g}Irganox 1010 is a phenolic antioxidant available from BASF.

### Examples

Molten adhesives at 149-160° C. were coated to the nonwoven substrate using a slot applicator nozzle at the add-on levels noted in Table 2. After coating the nonwoven with adhesive, the back sheet barrier film was then compressed to the nonwoven using steel nip rollers to form the final laminate. Experiments were performed at a line speed of 200 meters per minute. The nip rollers were monitored for build-up throughout the run. After one minute, the runs were stopped and the rollers closely inspected. Initial bond strengths were qualitatively determined and the spooled rolls of bilaminates were examined for signs of blocking (i.e., inter-laminate bonding resulting from bleed through of adhesive during processing). A semi-quantitative scale of was employed to gauge the level of equipment build-up with a 4.0 representing excessive build-up (full lines across the rollers as well as nonwoven fibers) and 0.0 denoting the rolls to be completely free of any contamination. Runs were performed at several nip roller temperatures for each adhesive to determine the role of this variable on bleed through performance. Results for two systems tested are summarized below:

TABLE 2

| | Adhesive | Test | Add-on, | Nip | Gap, | Build-up | | | |
|---|---|---|---|---|---|---|---|---|---|
| Example | T, ° C. | Adhesive | gsm | T, ° C. | mil | In-Run | Post-Run | Blocking | Comments |
| 1A* | 149 | H20080 | 10.0 | 23 | 3.0 | 0.00 | 0.00 | none | No Build-up (“BU”) |
| 1B* | 149 | H20080 | 10.0 | 38 | 3.0 | 3.00 | 3.00 | none | BU increased slowly. |
| | | | | | | | | | NW fibers build-up |
| | | | | | | | | | on ⅓ of roll. |
| 1C* | 149 | H20080 | 10.0 | 50 | 3.0 | 2.00 | 0.00 | none | BU during run, but self |
| | | | | | | | | | cleaned during ramp |
| | | | | | | | | | down. No blocking |
| | | | | | | | | | due to non-treated |
| | | | | | | | | | backside of film. |
| 1D | 149 | H20080 | 10.0 | 50 | 3.0 | 2.00 | 0.25 | medium | BU during run - |
| | | | | | | | | | cleaned up during |
| | | | | | | | | | ramp down. Light |
| | | | | | | | | | blocking in roll. |
| 1E | 149 | H20080 | 10.0 | 80 | 0.0 | 0.00 | 0.00 | heavy | No BU during run. |
| | | | | | | | | | Blocking higher than |
| | | | | | | | | | 1D. |
| 2A | 149 | H4356 | 10.0 | 23 | 3.0 | 0.00 | 0.00 | none | No BU. No blocking. |
| 2B | 149 | H4356 | 10.0 | 38 | 3.0 | 2.00 | 0.25 | none | BU during run. All |
| | | | | | | | | | cleaned off during |
| | | | | | | | | | ramp down. |
| 2C | 149 | H4356 | 10.0 | 50 | 3.0 | 3.00 | 3.00 | none | BU during run. Fiber |
| | | | | | | | | | picking did not clean |
| | | | | | | | | | off. |
| 2D | 149 | H4356 | 10.0 | 60 | 3.0 | 0.00 | 0.00 | none | No noise during run |
| 2E | 149 | H4356 | 10.0 | 80 | 3.0 | 0.50 | 0.00 | none | Zipping during run, |
| | | | | | | | | | suggestive of BU. |
| | | | | | | | | | Nothing left after |
| | | | | | | | | | ramp down. |
| 2F | 149 | H4356 | 10.0 | 90 | 3.0 | 0.00 | 0.00 | none | No BU during run |
| 2G | 149 | H4356 | 10.0 | 60 | 3.0 | 1.00 | 0.00 | none | Zipping heard during |
| | | | | | | | | | run All cleaned off |
| | | | | | | | | | during ramp down. |
| 2H | 149 | H4356 | 10.0 | 60 | 3.0 | 0.75 | 0.00 | none | Zipping heard again |
| | | | | | | | | | and faintly visible |
| | | | | | | | | | BU. |
| 3A | 160 | Ex 3 | 13.0 | 23 | 1.0 | 2.00 | 0.75 | none | BU gradually built |
| | | | | | | | | | to high level. Very |
| | | | | | | | | | zippy sound. |
| | | | | | | | | | Cleaned off during |
| | | | | | | | | | ramp down. Zero |
| | | | | | | | | | blocking |
| 3B | 160 | Ex 3 | 13.0 | 38 | 1.0 | 2.00 | 0.75 | none | Very zippy sound. A |
| | | | | | | | | | lot cleaned off |
| | | | | | | | | | during ramp down.. |
| 3C | 160 | Ex 3 | 13.0 | 50 | 1.0 | 1.00 | 0.00 | none | Intermittent BU during |
| | | | | | | | | | run All cleaned off |
| | | | | | | | | | during ramp down. |
| 3D | 160 | Ex 3 | 13.0 | 60 | 1.0 | 0.00 | 0.00 | none | Light zipping heard, |
| | | | | | | | | | but nothing visible |
| | | | | | | | | | on roll during run. |
| 3E | 160 | Ex 3 | 13.0 | 80 | 1.0 | 0.00 | 0.00 | 0 | Zero sound - zero BU. |

Table Notes:
all runs employ Clopay BR134 film except those noted* which employed DH284 film;

As shown in the Example 1A, running with a nip temperature of 23° C.—a value below the Tg of the H20080 adhesive—leads to clean laminate manufacturing. Increasing the nip temperature from 23 to 38° C., in the case of Example 1B, however, leads to dramatic increases in equipment build-up. In-run and post-run build-up continues to be seen at nip temperatures of 50° C. (Example 1D). Only until nearing nip temperatures close to the Tx of the adhesive at 80° C. is build-up on the equipment fully eliminated (Example 1E). The lower build-up is accompanied by considerable roll blocking in the spooled laminate produced in Experiment 1E suggesting that high nip temperatures are allowing H20080 to maintain greater fluidity allowing any adhesive that bleeds through the substrate and comes into contact with the rollers to be more easily wiped clean. While this represents a route to reduce equipment build-up using H20080, it may not be as suitable in applications where laminates are spooled immediately after fabrication.

Similar trends of equipment build-up relative to the rheological glass transition and crossover points of the adhesive are seen in the Example 2 test series employing H4356. Here, however, the reduction in adhesive build-up on process equipment when running at temperatures near the adhesive crossover does not lead to blocking in spooled rolls. This likely relates to the slightly higher overall modulus of H4356 and likely lower overall surface tack relative to H20080. This finding highlights the utility of this invention illustration, specifically that judicious adhesive design in conjunction with nip roller temperatures can be utilized to reduce fouling in the absence of blocking with permeable substrates.

The Example 3 series was produced using an adhesive containing a blend of semicrystalline polyolefin materials, and demonstrates the inventive method can be employed to reduce equipment build-up in non-SBc hot-melt adhesives. As shown in examples 3A, 3B, and 3C, it appears as if the lower Tg of the Example 3 adhesive makes controlling build-up difficult using reduced nip temperatures. Once nip temperatures are increased to values near or above the rheological crossover as in examples 3D (60° C.) and 3E (80° C.), build-up is fully eliminated. No blocking accompanies this reduction in build-up and little or no undesirable zipping sound can be heard. This behavior allows higher add on levels and tighter nip gaps to be employed to improve bonding even when using highly permeable, low-basis weight substrates.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention. Certain ranges or numerical limits are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number, and thus will typically refer to a number or value that is 10% below or above the specifically recited number or value.

We claim:

1. A method of using a hot melt adhesive, comprising the steps of:
heating a first circumferential roll to a temperature sufficient to at least significantly reduce build-up of adhesive on the first circumferential roll during operation;
applying a hot melt adhesive to an adhesive-receiving surface of a first permeable substrate, wherein the first permeable substrate has a circumferential roll-contacting surface opposed from the adhesive-receiving surface; and
conveying the first permeable substrate with the hot melt adhesive applied thereon such that the circumferential roll-contacting surface of the first permeable substrate contacts the heated first circumferential roll as the first permeable substrate is conveyed.

2. The method of claim 1 further comprising folding the first permeable substrate such that inner surfaces of the adhesive-receiving surface are adjacent with one another prior to the circumferential roll-contacting surface of the first permeable substrate contacting the heated first circumferential roll.

3. The method of claim 1 further comprising, after applying the hot melt adhesive to the adhesive-receiving surface of the first permeable substrate, contacting a second substrate with the adhesive-receiving surface of the first permeable substrate to form a bilaminate.

4. The method of claim 3, wherein the first circumferential roll comprises a first nip roller and the contacting step comprises exerting joining pressure on the first permeable substrate and the second substrate as the first permeable substrate and the second substrate are conveyed through a nip gap defined by the first nip roller and a second nip roller.

5. The method of claim 3, wherein the first circumferential roll comprises a first idler and the contacting step comprises exerting joining pressure on the first permeable substrate and the second substrate as the first permeable substrate and the second substrate are conveyed through at least one S-wrap curve formed by the first idler and a second idler positioned to contact the second substrate.

6. The method of claim 1 further comprising:
applying a hot melt adhesive to an adhesive-receiving surface of a second substrate, wherein the second substrate has a circumferential roll-contacting surface opposed from the adhesive-receiving surface;
conveying the second substrate with the hot melt adhesive applied thereon such that the circumferential roll-contacting surface of the second substrate contacts a second circumferential roll as the second substrate is conveyed;
introducing, after the steps of applying the hot melt adhesives to the adhesive-receiving surfaces of the first permeable substrate and the second substrate, a third substrate between the first permeable substrate and the second substrate; and
contacting the third substrate with the adhesive-receiving surfaces of the first permeable substrate and the second substrate to form a trilaminate.

7. The method of claim 6, wherein the first circumferential roll comprises a first nip roller and the contacting step comprises exerting joining pressure on the first permeable substrate, the second substrate, and the third substrate as the first permeable substrate, the second substrate, and the third substrate are conveyed through a nip gap defined by the first nip roller and a second nip roller.

8. The method of claim 6, wherein the first circumferential roll comprises a first idler and the contacting step comprises exerting joining pressure on the first permeable substrate, the second substrate, and the third substrate as the first permeable substrate, the second substrate, and the third substrate are conveyed through at least one S-wrap curve formed by the first idler and a second idler positioned to contact the second substrate.

9. The method of claim 1 wherein the hot melt adhesive has a glass transition temperature of less than 35° C.

10. The method of claim 1, wherein the hot melt adhesive composition contains a semicrystalline polymer.

11. The method of claim 10, wherein the semicrystalline polymer is a polyolefin.

12. The method of claim 11, wherein the polyolefin is selected from the group consisting of homopolymers, copolymers, and terpolymers derived from ethylene, propylene, 1-butene, 1-hexene, 1-octene and combinations thereof.

13. The method of claim 11, wherein the polyolefin is an ethylene-based polymer.

14. The method of claim 11, wherein the polyolefin is a propylene-based polymer.

15. The method of claim 1, wherein the first permeable substrate is a nonwoven.

16. The method of claim 3, wherein the second substrate is a permeable substrate.

17. The method of claim 1, wherein the hot melt adhesive is applied at an add-on level of from about 2 to about 20 grams per square meter.

18. The method of claim 6, wherein the third substrate is an elastic substrate.

19. The method of claim 18, wherein the elastic substrate is selected from the group consisting of stretch film, elastomeric strands, and a stretch-bonded laminate.

20. The method of claim 1, wherein the first circumferential roll is heated to a temperature of about 50° C. or higher.

21. The method of claim 1, wherein the first circumferential roll is heated to a temperature of about 60° C. or higher.

22. The method of claim 4, wherein the second substrate is a permeable substrate and the method further comprises the step of heating the second nip roller to a temperature sufficient to at least significantly reduce build-up of adhesive on the second nip roller during operation.

23. The method of claim 5, wherein the second substrate is a permeable substrate and the method further comprises the step of heating the second idler to a temperature sufficient to at least significantly reduce build-up of adhesive on the second idler during operation.

24. The method of claim 1, wherein the first circumferential roll is heated to a temperature of at least about 30° C. less than the crossover temperature of the hot melt adhesive.

25. The method of claim 1, wherein the first circumferential roll is heated to a temperature of at least about 20° C. less than the crossover temperature of the hot melt adhesive.

26. The method of claim 1, wherein the first circumferential roll is heated to a temperature of at least about the crossover temperature of the hot melt adhesive.

27. The method of claim 1, wherein the heating step is done prior to start-up.

28. The method of claim 1, wherein the heating step comprises using an external source of heat.

29. The method of claim 1 further comprising monitoring the temperature of the first circumferential roll during operation and controlling the amount of heat applied to the first circumferential roll to ensure that the temperature is maintained.
